(19) United States
(12) Patent Application Publication
(10) Pub. No.: US 2026/0319560 A1
(43) Pub. Date: Oct. 15, 2026

(54) TARGET COMPUTING UNIT, INITIATING COMPUTING UNIT, AND COMPUTING SYSTEM

(71) Applicant: Robert Bosch GmbH, Stuttgart (DE)

(72) Inventors: Matthias Haeberle, Erbach (DE); Olaf Grau, Weil Der Stadt (DE)

(21) Appl. No.: 19/257,802

(22) Filed: Jul. 2, 2025

(30) Foreign Application Priority Data
Jul. 8, 2024 (DE) 10 2024 206 423.8

(51) Int. Cl. G06F 1/3206; G06F 1/26; G06F 1/3296; H04B 3/54

(52) U.S. Cl. CPC G06F 1/3206; G06F 1/266; G06F 1/3296; H04B 3/548

(57) ABSTRACT

A target computing unit for a computing system having computing units that are supplied with a system voltage. The target computing unit includes: a voltage supply module including a supply port for the system voltage and configured to generate operating voltage(s) from the system voltage in an awake state when the system voltage is applied to the supply port and not generate the operating voltage(s) in a sleep state, a transceiver including two communication ports that are connected to or form two corresponding ports of the target computing unit, which can be or are connected to a two-wire data cable. The transceiver is supplied with at least one of the operating voltage(s). The voltage supply module is connected to the two ports of the target computing unit.

### FIELD

The present invention relates to a target computing unit, an initiating computing unit and a computing system comprising a target computing unit, and an initiating computing unit.

### BACKGROUND INFORMATION

In automation technology and vehicle technology, in particular in automotive engineering, so-called Single Pair Ethernet (SPE), which enables simple, inexpensive and robust cabling, can be used to provide data communication between control units. Ethernet connections are implemented using copper cables having only two wires, which makes it possible to achieve low weight and a small space requirement. Corresponding standards are specified by IEEE 802.3bp (1000BASE-T1), IEEE 802.3bw (100BASE-T1), IEEE 802.3ch (2.5/5.0/10 GBASE-T1) and IEEE 802.3cy (25/50/100 GBASE-T1), for example (IEEE: Institute of Electrical and Electronics Engineers).

To reduce energy consumption, for example to prevent a vehicle battery of a vehicle with numerous control units from being discharged completely when the vehicle is parked for long periods of time, it can be provided that the supply of a battery voltage or system voltage to specific control units (referred to in automotive terminology as terminal 15 control units) be switched off completely, and/or that specific control units (referred to in automotive terminology as terminal 30 control units) be put into a sleep state, during periods in which the vehicle or more generally the machine is at least partly not in use.

### SUMMARY

According to the present invention, a target computing unit, an initiating computing unit, and a computing system comprising such a target computing unit and such an initiating computing unit are provided. Advantageous example embodiments of the present invention are described herein.

Within the scope of the present invention, a transceiver and a voltage supply module are provided in a target computing unit intended for a system consisting of a plurality of computing units that are supplied with a system voltage, wherein the voltage supply module comprises a supply port for the system voltage and is configured to generate one or more operating voltages from the system voltage in an awake state when the system voltage is applied to the supply port and not generate the one or more operating voltages in a sleep state, and wherein the transceiver comprises two communication ports that are connected to or form two corresponding ports of the target computing unit, wherein the ports can be or are connected to a two-wire data cable, and wherein the transceiver is supplied with the one or at least one of the plurality of operating voltages. The voltage supply module is connected to the two ports of the target computing unit and, when system voltage is applied to the supply port and the voltage supply module is in the sleep state, is configured to switch from the sleep state to the awake state in response to a DC voltage with a control voltage level being applied between the two ports.

The present invention enables the implementation of a sleep state in which the energy consumption of the target computing unit is very low, wherein in particular the transceiver does not consume any energy. At the same time, waking up, i.e. the transition from the sleep state to the awake state, is enabled without the need to provide additional connections between control units, for example in the form of cables or the like.

The target computing unit is a to-be-woken-up computing unit, wherein the wake-up process can be triggered or initiated by another computing unit (initiating computing unit) that is connected via a data cable.

It is assumed that the target computing unit is supplied with the system voltage when it is in the sleep state. The target computing unit is therefore in particular not disconnected from the system voltage when it is put into the sleep state, e.g. by a switch.

The term control voltage level is intended to refer to a different from zero voltage with a specific level (e.g. in the range of 2 V to 6 V, etc.) and/or a voltage that has at least a specific level (e.g. over 2 V, over 3 V, over 4 V or over 5 V, etc.), and/or a voltage that has a level in a specific range (e.g. between 2 V and 7 V or between 3 V 5 V, etc.) between a minimum voltage and a maximum voltage.

According to one example embodiment of the present invention, the target computing unit further comprises a coupling device, via which the voltage supply module is connected to the two ports of the target computing unit, wherein the coupling device is configured to decouple a DC voltage component of a voltage applied to the ports, and/or wherein the coupling device comprises at least one filter element, in particular a component with a specific inductance, which is respectively disposed between one of the two ports and the voltage supply module. The coupling device in particular forms a low-pass filter, wherein the cutoff frequency is selected such that it lies below the frequency used by the transceiver for data transmission.

According to one example embodiment of the target computing unit of the present invention, the voltage supply module comprises a first signal port which is connected to one of the two ports, wherein, if a coupling device is provided, the first signal port is connected to the one of the two ports via the coupling device.

According to one example embodiment of the target computing unit of the present invention, the voltage supply module comprises a second signal port which is connected to the other of the two ports, wherein, if a coupling device is provided, the second signal port is connected to the other of the two ports via the coupling device.

According to an example embodiment of the present invention, alternatively or additionally, the other of the two ports is connected to a ground line which is connected to the voltage supply module, wherein, if a coupling device is provided, the other of the two ports is connected to the ground line via the coupling device.

According to one example embodiment of the present invention, the target computing unit comprises a controller which is supplied with the one or at least one of the plurality of operating voltages, wherein the controller is connected to the transceiver and is configured to exchange data with the other computing unit via the transceiver when a transceiver of another computing unit is connected to the transceiver of the target computing unit via a data cable.

According to one example embodiment of the target computing unit of the present invention, the controller is further configured to control the voltage supply module to switch from the awake state to the sleep state when a message indicating a sleep signal and/or a sleep instruction is received via the transceiver. The message indicating a sleep signal and/or a sleep instruction is sent by an initiating computing unit according to the present invention, for example.

An initiating computing unit according to an example embodiment of the present invention for a system consisting of a plurality of computing units comprises a transceiver with two communication ports that are connected to or form two corresponding ports of the initiating computing unit, wherein the ports can be or are connected to a two-wire data cable, an infeed device, which is connected to the two ports and can be switched in a controllable manner between a first and a second state, wherein, in the first state, a DC voltage with a predetermined signal voltage level is generated between the two ports, and, in the second state, the DC voltage is not generated between the two ports, and a controller which is configured to control the infeed device, and, if the system is to be started, control the infeed device such that it is switched to the first state.

According to this aspect of the present invention, a computing unit is provided, which is a waking-up computing unit, or which initiates a wake-up process, and can be referred to as an initiating computing unit or activating computing unit, by means of which a connected computing unit (target computing unit) that is in a sleep state can easily be woken up, i.e. can be put in the awake state, during a system startup from a sleep mode via a data cable connected to the ports.

The need for a system startup can be determined in the computing unit, for example by receiving an external signal and/or an external instruction, such as a start signal and/or start instruction. The start signal and/or the start instruction can be generated, e.g. by an external computing unit and/or a user interface (which detects the pressing of a button, for instance; for example, on the ignition key of a vehicle). Alternatively or additionally, the need for a system startup can also be determined internally in the computing unit, e.g. on a time-controlled basis and/or in response to a specific event, for example when measured values transmitted from a sensor to the computing unit exceed or fall below a certain threshold.

According to one example embodiment of the initiating computing unit of the present invention, the controller is further configured to control the infeed device such that it is switched to the second state at the end of a certain period of time if the system is to be started, wherein the period of time is measured from the time point at which the infeed device was controlled such that it switched to the first state, and/or wherein the controller is further configured to control the infeed device upon receipt of a message via the transceiver when the infeed device is in the first state such that it is switched to the second state, wherein the message is in particular any message. According to these embodiments, the supply of the DC voltage is terminated after the target computing unit or its voltage supply module has reached the awake state (receipt of a message) or it can be assumed that this is the case (expiration of the time period). The received message can be any message indicating that the transceiver and the controller of the target computing unit are in operation. Alternatively, the message (used in the configuration) can be a message with a predetermined content.

According to one example embodiment of the initiating computing unit of the present invention, the infeed device comprises or is connected to a voltage source for the signal voltage level. The infeed device comprises infeed connections via which the voltage source is connected to the ports and at least one of the infeed connections comprises a switching element that can be controlled by the controller to selectively switch the connection between the voltage source and at least one of the two ports into a conductive or a non-conductive state. Alternatively, the controller is configured to control the voltage source such that it selectively either provides the DC voltage with the signal voltage level or does not provide any voltage.

According to one example embodiment of the initiating computing unit of the present invention, the infeed device comprises a coupling device, wherein the coupling device is configured to decouple an AC voltage or an alternating current at the ports from the infeed device.

According to one example embodiment of the present invention, the coupling device comprises at least one filter element, in particular a component with a specific inductance, which is disposed in the infeed connections. The phrase “component with a specific inductance” is intended here and also above to mean that this is not a parasitic inductance that may potentially occur. The magnitude of the inductance can be dimensioned such that in particular signals with a frequency that corresponds at least to the frequency at which the transceiver transmits or receives data signals are filtered out or attenuated, so that it forms a low-pass filter.

According to one example embodiment of the initiating computing unit of the present invention, the controller is configured to send a message indicating a sleep signal and/or a sleep instruction via the transceiver when the computing system is to be stopped or put into a sleep state.

According to one example embodiment of the target computing unit of the present invention and/or the initiating computing unit of the present invention, the controller is configured to exchange data with the other computing unit via the transceiver when a transceiver of another computing unit is connected to the transceiver of the initiating computing unit via a data cable.

The data exchange or data transmission is carried out in accordance with one of the Ethernet communication protocols, for instance, for example as specified in the standards IEEE 802.3bw-2015, IEEE 802.3bp-2016, IEEE 802.3ch-2020, IEEE 802.3cy-2023 or IEEE 802.3cg-2019.

According to one example embodiment of the target computing unit of the present invention and/or the initiating computing unit of the present invention, the signal voltage level is less than 50% or 25% or 10% of a system voltage level, and/or the signal voltage level is less than 5 V or 3 V, and/or the signal voltage level is less than the minimum voltage for the power sourcing equipment of each one of the PoDL classes according to IEEE 802.3 bu, and/or the maximum electrical power that can be provided at the ports by the infeed device is less than a predetermined power limit, wherein the power limit is in particular less than 0.2 W and/or less than 0.1 W and/or less than the maximum power that can be provided by the power sourcing equipment of each one of the PoDL classes according to IEEE 802.3 bu. Due to the low power to be transmitted, the filter elements can in particular be small (for example with a small conductor cross-section) and can therefore be associated with low space requirements and low costs. “PoDL” stands for “Power over Data Line”, which enables power to be supplied to terminal devices via Ethernet cables. IEEE 802.3bu and IEEE 802.3ch, for instance, specify the parallel supply of energy via two-wire Ethernet cables.

A computing system according to an example embodiment of the present invention comprises a target computing unit according to the present invention and an initiating computing unit according to the present invention, wherein the target computing unit and the initiating computing unit are connected via an-in particular two-wire-data cable. Of course, the computing system can comprise more than one target computing unit and an initiating computing unit. The initiating computing unit can in particular comprise a plurality of transceivers and corresponding ports that are connected to a plurality of target computing units via data cables. The infeed device of the initiating computing unit can be connected (e.g. via respective coupling devices) to all of the ports (that are assigned to the transceivers) in parallel, so that the DC voltages with the signal voltage level are generated in parallel on the data cables. Alternatively, a plurality of infeed devices can be provided.

The term “connected” or “connection” in the context of this application refers to electrically conductive connections unless otherwise noted or it is clear from the context that it is not an electrically conductive connection. Similarly, the terms “voltage” and “current” refer to electrical voltages or electrical currents.

Further advantages and example embodiments of the present invention will emerge from the description herein and the figures.

The present invention is illustrated schematically in the figure on the basis of embodiment examples and is described in detail in the following with reference to the figures.

### BRIEF DESCRIPTION OF THE DRAWINGS

FIG. 1 shows a system comprising computing units according to example embodiments of the present invention.

### DETAILED DESCRIPTION OF EXAMPLE EMBODIMENTS

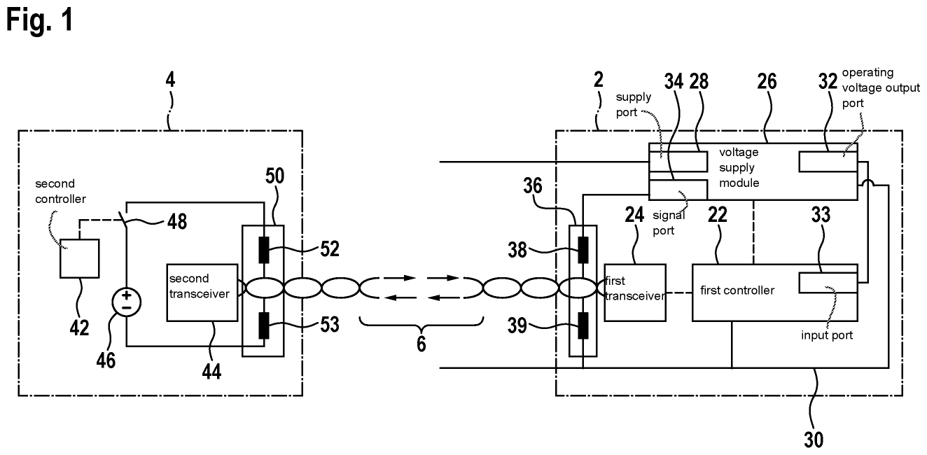

FIG. 1 shows a computing system comprising computing units according to embodiments of the present invention. Shown are a first computing unit 2 (target computing unit) and a second computing unit 4 (activation computing unit), wherein essentially only those elements or components of the computing units are shown that are used as part of one or more example embodiments of the present inventions.

The first computing unit 2 comprises a first transceiver 24 (known as PHY), which comprises two first communication ports that are connected via corresponding two ports on the first computing unit 2 (e.g. leading out of a housing wall of the computing unit) to a two-wire data cable 6; e.g. by means of a plug connection or by means of solder joints or the like. The first communication ports can also themselves form the first ports; for example if the first transceiver is accordingly configured and disposed as an assembly (e.g. with its own housing, which is disposed such that it projects through the housing wall of the first computing unit on the side with the communication ports). The first computing unit 2 can also comprise a first controller 22, which, for example, implements specific functionalities by executing corresponding computer programs.

The second computing unit 4 comprises a second controller 42, which, for example, implements specific functionalities by executing corresponding computer programs. The second computing unit 4 further comprises a second transceiver 44 (known as PHY), which comprises two second communication ports that are connected via corresponding two ports on the second computing unit 4 (e.g. leading out of a housing wall of the computing unit) to the two-wire data cable 6; e.g. by means of a plug connection or by means of solder joints. The second communication ports can also themselves form the second ports, for example if the second transceiver is accordingly configured and disposed as an assembly.

The first and the second controller 22, 42 can exchange data with one another via data cable 6 using the transceivers 24, 44. The first and the second transceivers 24, 44 are Ethernet transceivers, for example; in particular for Single Pair Ethernet (SPE) in accordance with one of the standards IEEE 802.3bw-2015, IEEE 802.3bp-2016, IEEE 802.3ch-2020, IEEE 802.3cy-2023 or IEEE 802.3cg-2019.

The first computing unit 2 further comprises a voltage supply module 26 with a supply port 28 for a system voltage (e.g. a battery voltage), which is connected to a supply line 29, for instance. The voltage supply module 26 can also be connected to a ground potential or a ground voltage (e.g. vehicle ground if the system is used in a vehicle) ; e.g. via a ground line 30. The voltage supply module 26 serves to generate one or more operating voltages from the system voltage (and to regulate them to at least a specific operating voltage level or to at least a specific operating voltage magnitude), and to provide them to components of the computing unit, e.g. the first controller 22 and/or the first transceiver 24. The figure shows an operating voltage output port 32 of the voltage supply module 26, for example, which is connected to a corresponding operating voltage input port 33 of the first controller 24.

The voltage supply module 26 has an awake mode or awake state and a sleep mode or sleep state. In the awake state, when the system voltage is applied to the supply port 28, the one or more operating voltages are generated by the voltage supply module and provided in the first computing unit 2 for other components (apart from the voltage supply module). In the sleep state, even when the system voltage is applied to the supply port 28, no operating voltage is provided in the first computing unit 2 by the voltage supply module 26.

The first controller 22 is in particular configured to control the voltage supply module 26 (illustrated as a dashed line) such that it switches from the awake state to the sleep state. The first controller 22 can carry out this control in response to a sleep instruction and/or a sleep signal received (in the form of a message) via the data cable 6 and the first transceiver 24, for example. The control of the voltage supply module 26 can take place immediately after the time of receipt at which the sleep instruction and/or the sleep signal is received, or after a period of time (beginning with the time of receipt) in which functions currently being carried out, for instance by the first controller 22 or other components of the first computing unit are terminated (shutdown).

The voltage supply module 26 comprises a (first) signal port 34 and is configured to, when the system voltage is applied to the supply port 28, transition or switch from the sleep state to the awake state when a DC voltage with a specific signal voltage level or a specific signal voltage magnitude is applied or occurs at the signal port 34. This DC voltage represents a DC voltage between the two first ports, i.e. between the two wires of the two-wire data cable 6. To detect this DC voltage at the voltage supply module 26, the voltage supply module 26 is also connected to the other of the two first ports, here, for example, via the ground line 30. In addition to the connection via the ground line, it is also possible that a further (second) signal port is provided on the voltage supply module that is connected to the other of the two first ports (not shown).

Since the operating voltages in the first computing unit 2 are provided by the voltage supply module 26 after the transition to the awake state, the components of the computing unit are supplied with voltage and in particular the first controller 22 is started.

The DC voltage between the wires of the data cable 6 is generated by the second computing unit 4, which for this purpose comprises an infeed device that is connected to the two second ports (of the second computing unit). The infeed device can be switched in a controllable manner between a first and a second state, wherein, in the first state, the DC voltage with a predetermined signal voltage level is generated between the two ports, and, in the second state, no voltage is generated between the two second terminals and in particular the DC voltage is not generated between the two second terminals.

The infeed device comprises or is connected to a voltage source 46 for the system voltage level, for example. The voltage source 46 is connected to the two second ports via two infeed connections, wherein a switching element 48 is provided in one of the infeed connections in order to be able to selectively switch the infeed connection between the voltage source 46 and the corresponding second port into a conductive or a non-conductive state. The switching element 48 can be controlled by the second controller 42. Alternatively, if no switching element is provided, the controller 42 can be configured to directly control the voltage source 46 such that it selectively either provides the DC voltage with the signal voltage level or does not provide any voltage.

The second controller 42 is configured to control the infeed device and, if the system is to be started, control the infeed device such that it is switched to the first state; e.g. switch the switching element 48 to the conductive state, so that the DC voltage with the signal voltage level is accordingly applied between the two second ports. To determine whether the system should be started, the controller 42 can receive an external signal and/or an external instruction, for example; for instance from a user interface and/or another computing unit. Alternatively or additionally, the occurrence of a specific event can be used to determine whether the system should be started; for example a specific point in time within the framework of a time control or when measured values from a sensor acquired in the second computing unit exceed or fall below a threshold value.

The second controller 42 can further be configured to send a message containing a sleep instruction and/or a sleep signal via the second transceiver 44. This occurs in particular when the computing system (comprising the first and the second computing unit) is to be put into a sleep state. To determine whether the computing system should be put into a sleep state, the same procedure as for determining whether the system should be started can be followed.

In each of the two computing units 2, 4, a filter device or coupling device (first coupling device 36 in the first computing unit 2; second coupling device 50 in the second computing unit 4) is provided, via which the DC voltage is coupled into or out of the data cable 6. The coupling device 36, 50 are in particular low-pass filters with a cutoff frequency that is below a transmission frequency used by the transceivers 24, 44. Each one of the coupling devices comprises filter elements. In particular filter elements 38, 39 of the first coupling device 38 and filter elements 52, 53 of the second coupling device 50 are provided, which are coils, chokes or the like, or elements with a specific inductance. Filter elements, in particular capacitors, can also be provided between the first ports of the first computing unit 2 and the first communication ports of the first transceiver 24 or between the second ports of the second computing unit 4 and the second communication ports of the first transceiver 24 (not shown). Such capacitors can already be integrated in the first transceiver 24 or in the second transceiver 44 (e.g. as input capacitors), so that they do not need to be provided separately. The filter elements can also include resistances.

The shown filter elements 38, 39, 52, 53 (inductances) are respectively connected between one of the first or second ports and the voltage supply module 26 or the voltage source 46. The filter element 38 is connected between one of the first ports and the (first) signal port 34, for example, or the one of the first ports and the (first) signal port 34 are connected to one another via the filter element 38. The filter element 39 is connected between the other of the first ports and the ground line 30 (or, if applicable, the second signal port), for instance, or the other of the first ports and the ground line 30 (or, if applicable, the second signal port) are connected to one another via the filter element 38. The filter element 52 is connected between one of the second ports and a first port (pole) of the voltage source 46, for example, or is provided in the corresponding infeed connection; i.e. the one of the second ports and the first port of the voltage source 46 are connected via the filter element 52 and the switching element 48. The filter element 53 is connected between the other of the second ports and a second port of the voltage source 46, for example, or is provided in the corresponding infeed connection; i.e. the other of the second ports and the second port of the voltage source 46 are connected via the filter element 53.

Because only a (relatively low) signal voltage level is used to wake up the first computing unit, and in particular no or only very little power is transmitted or the occurring currents are very low, the filter elements can be designed such that they are correspondingly small, e.g. with small conductor cross-sections, and cost-efficient.

1-15. (canceled)

16. A target computing unit for a computing system which includes a plurality of computing units that are supplied with a system voltage, the target computing unit comprising:
a voltage supply module, which includes a supply port for the system voltage and is configured to generate one or more operating voltages from the system voltage in an awake state when the system voltage is applied to the supply port and not generate the one or more operating voltages in a sleep state; and
a transceiver including two communication ports that are connected to or form two corresponding ports of the target computing unit, wherein the two ports can be or are connected to a two-wire data cable, wherein the transceiver is supplied with the one or at least one of the plurality of operating voltages;
wherein the voltage supply module is connected to the two ports of the target computing unit and, when system voltage is applied to the supply port and the voltage supply module is in the sleep state, is configured to switch from the sleep state to the awake state in response to a DC voltage with a control voltage level being applied between the two ports.

17. The target computing unit according to claim 16, further comprising:
a coupling device via which the voltage supply module is connected to the two ports of the target computing unit;
wherein: (i) the coupling device is configured to decouple a DC voltage component of a voltage applied to the two ports, and/or (ii) the coupling device includes at least one filter element including a component with a specific inductance, which is respectively disposed between one of the two ports and the voltage supply module.

18. The target computing unit according to claim 16, wherein the voltage supply module includes a first signal port which is connected to one of the two ports.

19. The target computing unit according to claim 18, further comprising:
a coupling device via which the voltage supply module is connected to the two ports of the target computing unit;
wherein: (i) the coupling device is configured to decouple a DC voltage component of a voltage applied to the two ports, and/or (ii) the coupling device includes at least one filter element including a component with a specific inductance, which is respectively disposed between one of the two ports and the voltage supply module; and
wherein the first signal port is connected to the one of the two ports via the coupling device.

20. The target computing unit claim 19, wherein:
(i) the voltage supply module comprises a second signal port which is connected to the other of the two ports, and wherein, the second signal port is connected to the other of the two ports via the coupling device, and/or (ii) the other of the two ports is connected to a ground line which is connected to the voltage supply module, and the other of the two ports is connected to the ground line via the coupling device.

21. The target computing unit according to claim 16, further comprising:
a controller which is supplied with the one or at least one of the plurality of operating voltages, wherein the controller is connected to the transceiver and is configured to exchange data with another computing unit via the transceiver when a transceiver the other computing unit is connected to the transceiver of the target computing unit via a data cable.

22. The target computing unit according to claim 21, wherein the controller is further configured to control the supply module to switch from the awake state to the sleep state when a message indicating a sleep signal and/or a sleep instruction is received via the transceiver.

23. The target computing unit according to claim 16, wherein: (i) a signal voltage level is less than 50% of a system voltage level, and/or (ii) the signal voltage level is less than 5 V, and/or (iii) the signal voltage level is less than a minimum voltage for power sourcing equipment of each PoDL class according to IEEE 802.3 bu.

24. An initiating computing unit for a computing system including a plurality of computing units, the initiating computing unit comprising:
a transceiver including two communication ports that are connected to or form two corresponding ports of the initiating computing unit, wherein the two ports can be or are connected to a two-wire data cable;
an infeed device, which is connected to the two ports and can be switched in a controllable manner between a first and a second state, wherein, in the first state, a DC voltage with a predetermined signal voltage level is generated between the two ports, and, in the second state, the DC voltage is not generated between the two ports; and
a controller, which is configured to control the infeed device and, if the system is to be started, control the infeed device such that the infeed device is switched to the first state.

25. The initiating computing unit according to claim 24, wherein:
the controller is further configured to control the infeed device such that the infeed device is switched to the second state at an end of a certain period of time if the system is to be started, wherein the period of time is measured from the time point at which the infeed device was controlled such that it switched to the first state, and/or the controller is further configured to control the infeed device upon receipt of a message via the transceiver when the infeed device is in the first state such that the infeed device is switched to the second state, wherein the message is any message.

26. The initiating computing unit according to claim 24, wherein:
the infeed device includes or is connected to a voltage source for the signal voltage level, wherein the infeed device includes infeed connections via which the voltage source is connected to the ports; and
at least one of the infeed connections includes a switching element that can be controlled by the controller to selectively switch the connection between the voltage source and at least one of the two ports into a conductive or a non-conductive state, or the controller is configured to control the voltage source such that the voltage source selectively either provides the DC voltage with the signal voltage level or does not provide any voltage.

27. The initiating computing unit according to claim 25, wherein the infeed device includes a coupling device, and wherein:
the coupling device is configured to decouple an AC voltage or an alternating current at the ports from the infeed device; and/or
the coupling device includes at least one filter element, the at least one filter including a component with a specific inductance, and the at least one filter is disposed in the infeed connections.

28. The initiating computing unit according to claim 24, wherein the controller is configured to send a message indicating a sleep signal and/or a sleep instruction via the transceiver when the computing system is to be stopped or put into a sleep state.

29. The initiating computing unit according to claim 24, wherein the controller is configured to exchange data with another computing unit via the transceiver when a transceiver of the other computing unit is connected to the transceiver of the initiating computing unit via a data cable.

30. The initiating computing unit according to claim 24, wherein: (i) the signal voltage level is less than 50% of a system voltage level, and/or (ii) the signal voltage level is less than 5 V, and/or (iii) the signal voltage level is less than a minimum voltage for power sourcing equipment of each PoDL class according to IEEE 802.3 bu, and/or (iv) a maximum electrical power that can be provided at the ports by the infeed device is less than a predetermined power limit, wherein the power limit is less than 0.5 W and/or less than 0.2 W and/or less than the maximum power that can be provided by the power sourcing equipment of each PoDL class according to IEEE 802.3 bu.

31. A computing system, comprising:
a target computing unit; and
an initiating computing unit;
wherein the target computing unit and the initiating computing unit are connected via a two-wire data cable;
wherein the target computing unit includes:
a voltage supply module, which includes a supply port for the system voltage and is configured to generate one or more operating voltages from the system voltage in an awake state when the system voltage is applied to the supply port and not generate the one or more operating voltages in a sleep state, and
a transceiver including two communication ports that are connected to or form two corresponding ports of the target computing unit, wherein the two ports can be or are connected to the two-wire data cable, wherein the transceiver is supplied with the one or at least one of the plurality of operating voltages;
wherein the voltage supply module is connected to the two ports of the target computing unit and, when system voltage is applied to the supply port and the voltage supply module is in the sleep state, is configured to switch from the sleep state to the awake state in response to a DC voltage with a control voltage level being applied between the two ports; and
wherein the initiating computing unit includes:
a transceiver including two communication ports that are connected to or form two corresponding ports of the initiating computing unit, wherein the two ports can be or are connected to the two-wire data cable,
an infeed device, which is connected to the two ports and can be switched in a controllable manner between a first and a second state, wherein, in the first state, a DC voltage with a predetermined signal voltage level is generated between the two ports, and, in the second state, the DC voltage is not generated between the two ports, and
a controller, which is configured to control the infeed device and, if the computing system is to be started, control the infeed device such that the infeed device is switched to the first state.
